(19) United States
(12) Patent Application Publication
(10) Pub. No.: US 2008/0045653 A1
(43) Pub. Date: Feb. 21, 2008

(54) Translucent Uv Permeable Panel Exhibiting Ir Reflecting Properties

(75) Inventors: Wolfgang Scharnke, Darmstadt (DE); Volker Mende, Darmstadt (DE)

Correspondence Address: OBLON, SPIVAK, MCCLELLAND MAIER & NEUSTADT, P.C., 1940 DUKE STREET, ALEXANDRIA, VA, 22314, US

(73) Assignee: Roehm GmbH, Darmstadt (DE)

(21) Appl. No.: 11/813,594

(22) PCT Filed: Nov. 3, 2005
(86) PCT No.: PCT/EP05/11757

§ 371 Date: Jul. 10, 2007

(30) Foreign Application Priority Data
Feb. 3, 2005 (DE) 10 2005 005 208.8

(51) Int. Cl. C08J 3/22; C08K 3/00; G02B 5/20; G02B 5/28

(52) U.S. Cl. 524/878

(57) ABSTRACT

The invention relates to UV adsorber-free tanning aids which contain IR-reflecting pigments.

The invention relates to UV-absorber-free tanning aids which comprise IR-reflecting pigments.

For tanning of the skin sunscreen creams and the like are usually used as tanning aids, in order to protect the skin from damage by UV radiation. A disadvantage of these aids is that creams of this type car trigger allergies in susceptible people. Furthermore, many of these substances are not water-resistant. They are washed off during bathing and are not reapplied. This carelessness can easily result in damage to the skin.

There are also known devices which use incorporated UV sources to bring about tanning of the skin. In this context, there are also known solarium-sunbed devices composed of PMMA and comprising large amounts of NEW stabilizers or UV absorbers in order to protect the plastic from degradation caused by UV radiation. However these do not permit tanning with sunlight. A disadvantage of these devices is the high energy consumption of the UV sources. There is also no intention that these systems be operated outdoors and the tanning process is therefore perceived as tedious.

JP 05078544 describes a methacrylic sheet which comprises coated mica and reflects radiated heat. The mica has a coating of titanium dioxide. The sheets thus modified are used for example to control the temperature in greenhouses.

EP-A 0 548 822 describes light-permeable IR-reflecting products with sunscreen action and thermal insulation action, examples being sheets, sandwich panels or skylights, with transmittance T of from 45 to 75% in the visible region (light transmittance for daylight (standard illuminant D65) τ_{D65}), with total energy permeation g of from 30 to 60% and with a T/g or τ_{D65}/g ratio >1.15 (to DIN 67 507), which can be produced by coextrusion or coating methods, such as lacquering, or by reverse-role coating, from a rigid, amorphous substrate material composed of light-permeable plastic and a light-permeable coating material with from 20 to 40% by weight content of IR-reflecting particles which are composed of a layer of thickness from 60 to 120 nm of titanium dioxide on a lamellar carrier pigment. The orientation of the IR-reflecting particles here is parallel to the surface, and they are present in a coating layer whose thickness is from 5 to 40 micrometers and which adheres to the substrate material, and which is composed of a transparent binder insoluble in water. TiO₂ pigments of rutile type are used in the examples. For the coextrusion process, selection of a binder whose melt viscosity is lower than that of the substrate material is recommended for the IR-reflecting layer. In order to avoid fracture of the pigments, a twin-screw extruder with tightly intermeshing counter rotating screws is used, and the pigment is incorporated directly into the melt.

Multiple-web sandwich panels composed of polymethyl methacrylate with coextruded IR-reflecting modification according to EP-A 0 548 822 are examples of commercially available products. Multiple-web sandwich panels composed of polycarbonate with corresponding IR-reflecting modification are also known, and for purposes of improved weathering resistance here there is also another coextruded layer comprising UV absorber on the coextruded pigment layer.

DE 196 18 569 A1 describes multilayer interference pigments, composed of a transparent carrier materials these having been coated with alternating layers of metal oxides with low and high refracted index, the difference in refracted index being at least 0.1. By way of example, this method can be used to equip mica lamellae with an alternating layer composed of TiO₂/SiO₂/TiO₂ Pigments as described in DE 196 18 569 A1 are suitable for pigmentation of agricultural foils, in order to provide protection from solar infrared radiation and thus to prevent excessive heating, for example of greenhouses.

DE 25 44 245 describes the use of sheets composed of poly ethyl methacrylate with content of light-reflecting particles oriented parallel to the surface. The pigment particles used here bring about selective reflection in the infrared region which can be characterized by a selectivity index greater than 1. The IR-reflecting pigments used comprise TiO₂, lead carbonate and bismuth oxychloride. The use of TiO₂ pigment of anatase type, deposited at a layer thickness of about 120 μm on mica lamellae is emphasized as particularly advantageous.

The particles are dispersed at concentrations of from 0.01 to 1% by weight in a partially polymerized methyl methacrylate. The suspension is then polymerized to completion in a cell between glass plates to give poly methyl methacrylate. If the cell here is stored horizontally, the pigment-mica particles present can become increasingly oriented parallel to the sheet surface as the material sinks, thus generating the desired IR-reflecting effect in the fully polymerized sheets. This parallel orientation of the IR-reflecting particles an be further improved if the glass plates of the cell are in addition made to undergo a circular motion a number of times with respect to one another while the polymerizing material is still in the gel state.

DE 25 44 245 moreover mentions the additional possibility of incorporating the IR-reflecting pigments in moulding compositions. The intention then is that the pigments become substantially oriented parallel to the surface during processing via calendering extrusion or injection moulding.

However, it has been found that this method cannot achieve an effect corresponding to EP-A 0 548 822. The orientation of the particles in a plastics product composed, for example, of extruded moulding composition with IR-reflecting pigment uniformly distributed therein is not as good as in a coextruded or lacquered separate layer. Another problem which appears to be general here is that corresponding particles have very high susceptibility to fracture. The less good orientation parallel to the surface combined with a comparatively high proportion of fracture generally lead to unsatisfactory results.

This applies in particular to plastics products with comparatively complicated geometry which deviate from simple sheet shape and whose production involves, during the extrusion process different melt flow directions and sheer forces which force the pigment particles into various orientation and with this also expose them to higher overall mechanical loads. JP-OS 08-53555 and JP-OS 08-52335 describe the extrusion and coextrusion of impact-modified acrylic plastic comprising IR-reflecting pigments. Because the two components are mixed under dry conditions, a high proportion of pigment fracture is unavoidable. The consequence of this is that the efficiency of IR reflection cannot be ideal when compared with the amount of pigment used, since the pigment fragments reduce transmittance but reflect IR radiation only poorly or not at all.

DE 10122315 describes a light-permeable, IR-reflecting plastics product composed entirely or at least to some extent of an impact-resistant thermoplastic comprising IR-reflecting pigments. A disadvantage of the impact-resistant plastics is that they are not weathering-resistant. UV absorbers therefore have to be used to modify impact-resistant plastics for outdoor applications.

In view of the prior art stated here, it was an object of the present invention to provide tanning aids which can be used to achieve natural tanning of the skin with the aid of sunlight, without any contact of the skin with sunscreen cream.

The object has been achieved via a translucent tanning aid, characterized in that the tanning aid encompasses a UV-absorber-free polymethyl methacrylate moulding with weathering-resistant IR-reflecting grades of pearl pigment.

For the purposes of the present invention, the term tanning aid is a device which encompasses at least one polymethyl methacrylate moulding which can be placed between the sunlight and a skin area to be tanned. Accordingly, this material can in particular be transparent roofing, preferably of buildings, or screens, for example permanently installed. Other suitable tanning aids are roofs which may be installed by way of example on ships, and in particular on pedaloes, electrically operated boats and the like. There are also possible applications in solarium construction or conservatory construction.

The material may moreover be transportable screens with fixed dimensions as a function of the thickness of the polymethyl methacrylate moulding, or which can be folded up.

Surprisingly, it has been found that addition of weathering-resistant IR-reflecting pearl pigments makes it unnecessary to add UV absorbers and IR-absorbers. The result is, for example, less heating of the material and of the space situated behind the material, because the IR radiation is reflected and not absorbed.

It is preferable to use weathering-resistant IR-reflecting grades of pearl pigment. These have particularly preferably been selected from the IRIODIN® group, particularly IRIODIN® 870 and IRIODIN® 875.

The inventive translucent tanning aid is weathering-resistant. There is no need to use UV absorbers. Consequently, it is possible that the UV light is transmitted. At the same time, the use of these pigments reflects the IR light. The consequence of this combination is that tanning of the skin by the UV radiation can take place at pleasant temperatures because reflection of the IR radiation protects the space situated behind the tanning aid from intense heating.

The inventive tanning aid encompasses a polymethyl methacrylate moulding. Polymethyl methacrylate (PMMA) is known per se to persons skilled in the art. The polymethyl methacrylate moulding preferably encompasses at least 30% by weight based on the weight of the polymethyl methacrylate moulding, of polymethyl methacrylate.

Polymethyl methacrylates are generally obtained via free-radical polymerization of mixtures which comprise methyl methacrylate. For production of polymethyl methacrylates, these mixtures may also comprise other (meth)acrylates which are copolymerizable with methyl methacrylate. The expression (meth)acrylates encompasses methacrylates and acrylates and mixtures of the two.

The polymethyl methacrylate moulding can moreover comprise other polymers, preferably those compatible with PMMA in order to modify properties. Among these are, inter alia, polyacrylonitriles, polystyrenes, polyethylene terephthalate glycol, polyethers, polyesters, polycarbonates and polyvinyl chlorides. The polymers may be used individually or as a mixture, and it is also possible here to use copolymers derivable from the abovementioned polymers.

The polymethyl methacrylate mouldings can be further processed by means of thermoplastic shaping processes, such as injection moulding or extrusion. The cell-casting process can also be used to produce the corresponding polymer mixtures.

Processing takes place via extrusion of moulding compositions, by first producing a premix of the IR-reflecting particles with a low-viscosity thermoplastic. From 0.25 to 25% by weight of IR-reflecting pigments are mixed with the melt of the low-viscosity thermoplastic, preferably polymethyl methacrylate, at a temperature of at least 280° C., preferably from 290° C. to 320° C., in an unpressurized, non-shearing zone of a twin-screw extruder, preferably of a corotating twin-screw extruder, and the materials are extruded and pelletized. The pellets are then directly, or in the form of a melt, mixed with the pellets of a polymethyl methacrylate, if appropriate with additives and/or with PMMA-compatible plastics, in an extruder, and the plastics mixture is extruded or coextruded together with another melt of a thermoplastic, in the desired shape. Once the extrudate has cooled, the product is the desired plastics moulding, which can, if appropriate, be further processed by familiar forming processes.

It has been found that the pigment in the pellet form has better protection from fracture if the IR-reflecting particles are mixed with the melt of the low-viscosity thermoplastic at a temperature of at least 280° C. in an unpressurized, non-shearing zone of a twin-screw extruder.

The proportion of fracture of the IR-reflecting pigment can be further reduced if, prior to premixing, pellets are produced, this being obtained by chopping the extrudate at a temperature or surface temperature of at least 50, preferably from 60 to 90° C. In this temperature range it appears that the pellets retain some degree of softness, which keeps pigment fracture to a very low level during the chopping procedure.

The polymethyl methacrylate moulding can moreover encompass other known additives, but there is a restriction on their amount, based on the intended use of the inventive tanning aids. Among these are, inter alia, antistatic agents, antioxidants, mould-release agents, flame retardants, lubricants, dyes, flow improvers, fillers, light stabilizers and organophosphorus compounds, such as phosphites or phosphonates, weathering stabilizers and plasticizers. Among the preferred additives are dyes which exhibit at least 30% transmittance at 350 nm when dissolved in methyl methacrylate at a concentration of 0.01% by weight. These dyes are known per se and are available by way of example with the trade marks ®Makrolex Blue RR, ®Makrolex Violet B, ®Makrolex Violet 3R, ®Makrolex Green 5B, ®Makrolex Green G, from Bayer, ®Sandoplast Blue 2B, ®Sandoplast Red BB, and ®Sandoplast Green G from Clariant, ®Mikrolitviol B-K from Ciba.

The examples given below are given for further illustration of the present invention, but do not restrict the invention to the features disclosed herein.

### EXAMPLES

### Example 1

Preparation of a premix in pellet form from a low-viscosity polymethyl methacrylate melt and IR-reflecting pigment.

The premix is prepared by incorporating 25% by weight of the pigment Iriodin® 870 (producer Merck KGaA Darmstadt, Germany) into the melt of a polymer composed of 91% by weight of methyl methacrylate and 9% by weight of methyl acrylate, at 300° C. The polymer here is melted and conveyed in a corotating twin-screw extruder (D=34, Leistritz). Pigment addition takes place by way of a side feed under unpressurized conditions in an unpressurized non-shearing extruder zone by way of a volumetric screw metering system. Pelletization to give pellets of length from 2.5 to 3.5 mm and diameter from 2 to 3 mm takes place at 80° C. (surface temperature).

### Example 2

### Production of a Translucent Tanning Aid

Processing takes place via extrusion of moulding compositions, by first producing a premix, as stated in example 1. The pellets produced are mixed directly with the pellets of a polymethyl methacrylate in an extruder. The resultant plastics mixture is extruded or is coextruded together with another melt of a thermoplastic, in the desired shape.

1. A translucent tanning aid, characterized in that the tanning aid comprises a moulding comprising a UV-absorber-free polymethyl methacrylate and a weathering-resistant IR-reflecting grade of pearl pigment.

2. The translucent tanning aid as claimed in claim 1, characterized in that the moulding comprises at least 30% of polymethyl methacrylate and, optionally, a PMMA-compatible plastic.

3. The translucent tanning aid as claimed in claim 1, characterized in that the weathering-resistant IR-reflecting grade of pearl pigment is selected from the IRIODIN® group.

4. The translucent tannin aid as claimed in claim 1, characterized in that IRIODIN® 870 or IRIODIN® 875 is used as the pearl pigment.

5. The translucent tanning aid as claimed in claim 1, characterized in that dyes, IR absorbers, flame retardants and/or antistatic agents are present in the moulding.

6. A process for the production of a translucent tanning aid as claimed in claim 1, said process comprising the steps of producing a premix comprising from 0.25 to 25% by weight of a IR-reflecting grade of pearl pigment and from 75-99.75% by weight of polymethyl methacrylate, extruding a moulding composition composed of the premix and at least 30% of polymethyl methacrylate and, optionally, further processing the resulting extrusion by means of forming processes.

7. The process for the production of a translucent tanning aid as claimed in claim 6, characterized in that the moulding composition to be extruded comprises the premix, polymethyl methacrylate and dyes, IR absorbers, flame retardants and/or antistatic agents.

8. A roofing system comprising translucent tanning aid as claimed in claim 1.

9. A method of using the translucent tanning aid as claimed in claim 1 in the construction sector, in solarium construction, in conservatory construction, as a roofing element or a facade element, and in shipbuilding.
